(19) United States
(12) Patent Application Publication
(10) Pub. No.: US 2017/0245305 A1
(43) Pub. Date: Aug. 24, 2017

(54) Wireless Communication Methods and Apparatus

(71) Applicant: Kabushiki Kaisha Toshiba, Tokyo (JP)

(72) Inventor: Russell John HAINES, Bristol (GB)

(73) Assignee: Kabushiki Kaisha Toshiba, Tokyo (JP)

(21) Appl. No.: 15/504,130

(22) PCT Filed: Mar. 10, 2015
(86) PCT No.: PCT/GB2015/050689

§ 371 Date: Feb. 15, 2017

(51) Int. Cl. H04W 74/08; H04W 72/04

(52) U.S. Cl. CPC H04W 74/0825; H04W 74/0816; H04W 72/0446

(57) ABSTRACT

In an embodiment, a method, in a source wireless station, of transmitting a data packet to a destination wireless station over a communication channel of a wireless network while the communication channel is in use for a communication exchange between a first wireless station and a second wireless station is disclosed. The method comprises: receiving a request to send message transmitted by the first wireless station on the communication channel, the request to send message comprising an indication of a duration that the communication channel will be in use during the communication exchange between the first wireless station and the second wireless station; determining if a clear to send message transmitted from the second wireless station to the first wireless station is received in an expected reception period following the request to send message; determining a transmission period, the transmission period being a part of the duration in which transmission on the communication channel by the source wireless station will not interfere with the communication exchange between the first wireless station and the second wireless station; comparing the duration of the transmission period with a duration required for transmission of the data packet; and transmitting the data packet during the transmission period if a clear to send message is not received in the expected reception period and the duration of the transmission period is longer than or equal to the duration required for transmission of the data packet.

### FIELD

Embodiments described herein relate generally to wireless communication and in particular to wireless channel reuse by a source wireless station based on partial reception of control messages exchanged by first and second wireless stations

### BACKGROUND

In contention based wireless networks, access to a wireless medium is determined by two processes. Firstly, wireless stations sense the wireless medium using clear channel assessment (CCA) techniques to monitor when the medium is in use by other stations. Secondly, medium access control (MAC) headers transmitted by stations include information that indicates the duration that the medium will be in used for message exchanges between two stations.

This Duration information gets loaded into a counter known as the Network Allocation Vector (NAV). Each station maintains its own NAV which indicates the remaining time that the medium will be in use.

### BRIEF DESCRIPTION OF THE DRAWINGS

In the following, embodiments will be described with reference to the accompanying drawings in which:

FIG. 1 shows an example of a hidden node in a wireless network;

FIG. 2 shows a request to send (RTS)/clear to send (CTS) exchange;

FIG. 3 shows an example of an exposed node scenario;

FIG. 4 shows an exposed node scenario;

FIG. 5 shows a second exposed node scenario;

FIG. 6 shows a communication exchange according to an embodiment;

FIG. 7 shows a wireless station according to an embodiment;

FIG. 8a shows a method of transmitting a data packet according to an embodiment;

FIG. 8b shows a method of transmitting a data packet according to an embodiment;

FIG. 9 shows the structure of a request to send (RTS) frame;

FIG. 10 shows the structure of a clear to send (CTS) frame;

FIG. 11 shows the calculation of the network allocation vector (NAV) value in the duration field of a request to send (RTS) frame;

FIG. 12 shows the calculation of the network allocation vector (NAV) value in the duration field of a clear to send (CTS) frame;

FIG. 13 shows a wireless communication method according to an embodiment;

FIG. 14 shows a wireless communication method according to an embodiment;

FIG. 15 shows a wireless communication method according to an embodiment; and

FIG. 16 shows a method of transmitting a data packet according to an embodiment.

### DETAILED DESCRIPTION

In an embodiment, a method, in a source wireless station, of transmitting a data packet to a destination wireless station over a communication channel of a wireless network while the communication channel is in use for a communication exchange between a first wireless station and a second wireless station is disclosed. The method comprises: receiving a request to send message transmitted by the first wireless station on the communication channel, the request to send message comprising an indication of a duration that the communication channel will be in use during the communication exchange between the first wireless station and the second wireless station; determining if a clear to send message transmitted from the second wireless station to the first wireless station is received in an expected reception period following the request to send message; determining a transmission period, the transmission period being a part of the duration in which transmission on the communication channel by the source wireless station will not interfere with the communication exchange between the first wireless station and the second wireless station; comparing the duration of the transmission period with a duration required for transmission of the data packet; and transmitting the data packet during the transmission period if a clear to send message is not received in the expected reception period and the duration of the transmission period is longer than or equal to the duration required for transmission of the data packet.

In an embodiment, determining if a clear to send message transmitted from the second wireless station to the first wireless station is received in an expected reception period following the request to send message comprises setting a timer for the duration of the expected reception period at the end of reception of the request to send message.

In an embodiment, the expected reception period has a duration of at least one short inter frame spacing and the duration of a clear to send message.

In an embodiment, the expected reception period has a duration of one short inter frame spacing, the duration of a clear to send message and a buffer period.

In an embodiment, the method further comprises detecting a collision between the data packet transmitted during the transmission period and the communication between the first wireless station and the second wireless station, and increasing the duration of the buffer period.

In an embodiment, the method comprises determining the transmission period as the period when the first wireless station will be transmitting to the second wireless station.

In an embodiment, the method further comprises comparing the length of the transmission period with the length of a plurality of candidate data packets and selecting a candidate data packet having a length less than the transmission period as the data packet.

In an embodiment, the method further comprises monitoring the communication channel during the transmission period and stopping the transmission of the packet if a transmission from a further wireless station is identified.

In an embodiment, the method further comprises determining the identity of the first wireless station from a transmitter address of the request to send message, and comparing the transmitter address of the request to send message with a destination address of a received clear to send message to determine that the clear to send message was transmitted in response to the request to send message.

In an embodiment, in a source wireless station, of transmitting a data packet to a destination wireless station over a communication channel of a wireless network while the communication channel is in use for a communication exchange between a first wireless station and a second wireless station is disclosed. The method comprises: receiving a clear to send message transmitted by the first wireless station on the communication channel, the clear to send message comprising an indication of a duration that the communication channel will be in use for the communication exchange between the first wireless station and the second wireless station; determining if a request to send message transmitted from the second wireless station to the first wireless station was received prior to reception of the clear to send message; if a request to send message was not received prior to reception of the clear to send message, determining a transmission period, the transmission period being a part of the duration in which transmission on the communication channel by the source wireless station will not interfere with the communication exchange between the first wireless station and the second wireless station; comparing the duration of the transmission period with a duration required for transmission of the data packet; and transmitting the data packet during the transmission period if the duration of the transmission period is longer than or equal to the duration required for transmission of the data packet.

In an embodiment, the method further comprises setting a timer for a duration of an expected reception period if a request to send message is received and determining that a request to send message was not received prior to reception of the clear to send message if the timer is not running or has expired when the clear to send message is received.

In an embodiment, a method, in a source wireless station, of transmitting a data packet to a destination wireless station over a communication channel of a wireless network while the communication channel is in use for a communication exchange between a first wireless station and a second wireless station is disclosed. The method comprises: receiving a request to send message transmitted by the first wireless station on the communication channel; determining if a clear to send message transmitted from the second wireless station to the first wireless station is received in an expected reception period following the request to send message; if a clear to send message is not received in the expected reception period, monitoring the communication channel; and transmitting the data packet while a signal from the first wireless station is received.

In an embodiment, a wireless station is disclosed. The wireless station comprises: a communication interface configured to receive a request to send messages and clear to send messages on a communication channel and to transmit messages on the communication channel; storage for a data packet to be transmitted on the communication channel; and a communication controller configured to: set a timer to an expected reception period when a request to send message is received by the communication interface, determine a transmission period from duration information included in the received request to send message, compare the duration of the transmission period with the duration required to transmit the data packet; and control the communication interface to transmit the data packet during the transmission period if no clear to send message in response to the request to send message is received before the timer expires and the duration of the transmission period is longer than or equal to the duration required to transmit the data packet.

In an embodiment, the storage is configured to store a queue of data packets and the communication controller is configured to compare the duration of the transmission period with the durations required for transmission of the data packets in the queue and identify a data packet having a duration required for transmission which is less than or equal to the duration of the transmission period.

In an embodiment, the communication controller is further configured to determine on reception of a clear to send message if the timer has expired, and if the timer has expired, determine a transmission period from duration information included in the received clear to send message, compare the length of the transmission period with the length of the data packet; and control the communication interface to transmit the data packet during the transmission period if the length of the transmission period is longer than the length of the data packet.

In an embodiment, the communication controller is further configured to monitor the communication channel during the transmission period and to stop the transmission of the packet if a transmission from a further wireless station is identified.

In an embodiment, the communication controller is further configured to store an indication of a transmitter address of a request to send message received by the communication interface, and compare the transmitter address of the request to send message with a destination address of a received clear to send message and determine that the clear to send message is in response to the request to send message if the transmitter address matches the destination address.

In an embodiment a wireless station is disclosed. The wireless station comprises: a communication interface configured to receive a request to send messages and clear to send messages on a communication channel and to transmit messages on the communication channel; storage for a data packet to be transmitted on the communication channel; and a communication controller configured to: set a timer to an expected reception period when a request to send message is received by the communication interface, if no clear to send message in response to the request to send message is received before the timer expires; monitor the communication channel to determine when a first wireless station that transmitted the request to send message is transmitting and control the communication interface to transmit the data packet while the first wireless station is transmitting.

In an embodiment a computer readable carrier medium carrying processor executable instructions is disclosed. The computer readable medium carries instructions which when executed on a processor cause the processor to execute a method according to an embodiment described above.

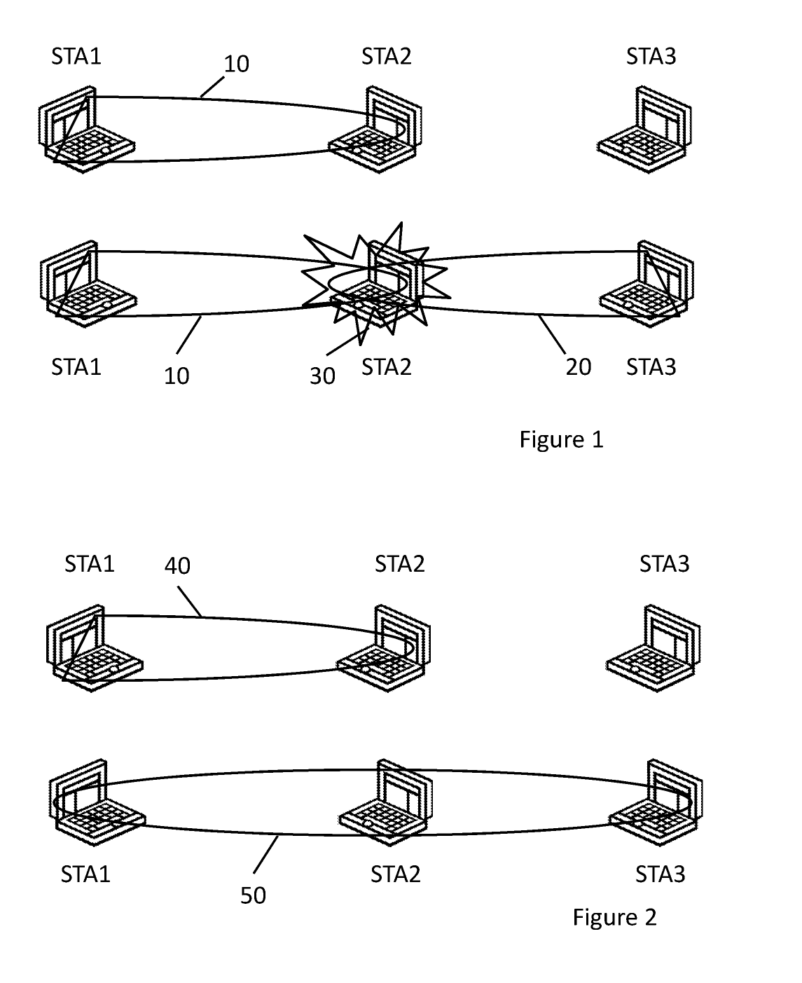

FIG. 1 shows an example of a hidden node in a wireless network. As shown in FIG. 1 a first wireless station STA1 transmits a transmission 10 on a wireless communication channel to a second wireless station STA2. A third wireless station STA3 is out of the range of the first station STA1 which is the source of the transmission 10. However, the third station STA3 is within range of the second station STA2 which is destination of the transmission 10. If the third station STA3 senses that the channel is clear and begins a transmission 20 on the same channel, at the second station STA2, the transmission 20 from the third station STA3 will interfere with the transmission 10 and cause a collision 30. In this scenario, the third station STA3 is known as a hidden node. A hidden node is a node that is not within range of the source of a transmission but is within range of the destination of the transmission.

In the IEEE 802.11 family of standards, Request-To-Send (RTS)/Clear-To-Send (CTS) exchanges are optionally used to avoid collisions due to hidden nodes.

FIG. 2 shows a RTS/CTS exchange. The first station STA1 transmits a RTS frame 40. The RTS frame includes a Duration value indicating the length of the ensuing CTS frame, the length of the DATA frame that will be transmitted, time for an acknowledgement (ACK) and the intervening short inter frame spacing (SIFS) gaps. In response, the second station STA2 which is the intended recipient of the DATA frame to be transmitted transmits a CTS frame 50. The CTS frame 50 also contains a Duration value that includes the ensuing DATA, ACK and the intervening SIFS gaps. Every station in range of the destination station STA2 now will have received the CTS frame 50 and will therefore have received an indication of how long the medium will be busy. When the third station STA3 receives the CTS frame it sets a Network Allocation Vector (NAV) which indicates a length of time set by the duration value in the CTS frame. The third station STA3 will not access the channel for the time indicated by the NAV value.

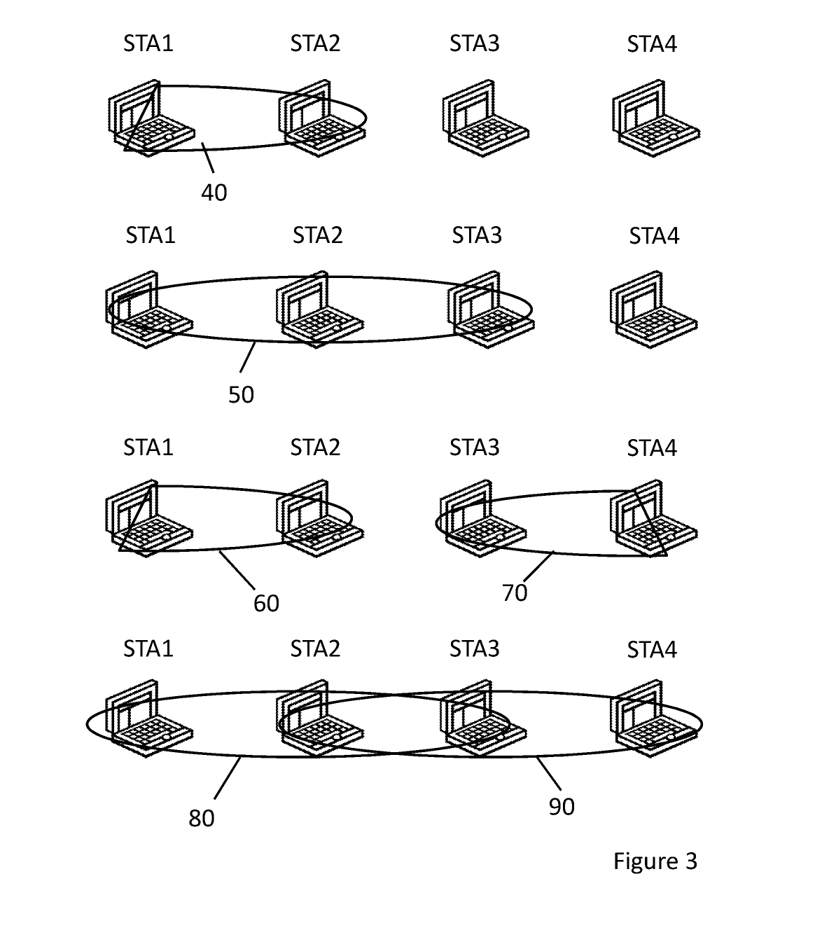

While the use of RTS/CTS exchanges avoids the hidden node scenario described above, it does lead to a further possible scenario, known as the exposed node which can result in a drain on efficient channel usage. An exposed node is one that is blocked from transmitting unnecessarily. This scenario is described below with reference to FIG. 3.

FIG. 3 shows an example of an exposed node scenario. A first station STA1 transmits a RTS frame 40 indicating an intended transmission to a second station STA2. In response, the second station STA2 transmits a CTS frame 50. A third station STA3 is within range of the second station STA2, but not within range of the first station STA2. A fourth station STA4 is out of range of the first station STA1 and the second station STA2, but within range of the third station STA3. This means that while STA1 is making a transmission 60 to STA2, a transmission 70 from the fourth station STA4 to the third station STA3 will not result in a collision. Additionally, a transmission 90 by the third station STA3 to the fourth station STA4 will not collide with a transmission 80 by the second station STA2 to the first station STA1 because the two receivers (STA1 and STA4) will only receive one signal each. If the third station STA3 relies on the NAV value set by the duration indicated by the CTS 50 sent by the second station STA2, it will be prevented from making the transmission 90. Thus, the third station STA3 shown in FIG. 3 is known as an exposed node.

In an embodiment, the reception of either the RTS or the CTS frame from a RTS/CTS exchange between first and second stations is used to identify an exposed node scenario in which a third station may send a transmission to a fourth station without collision.

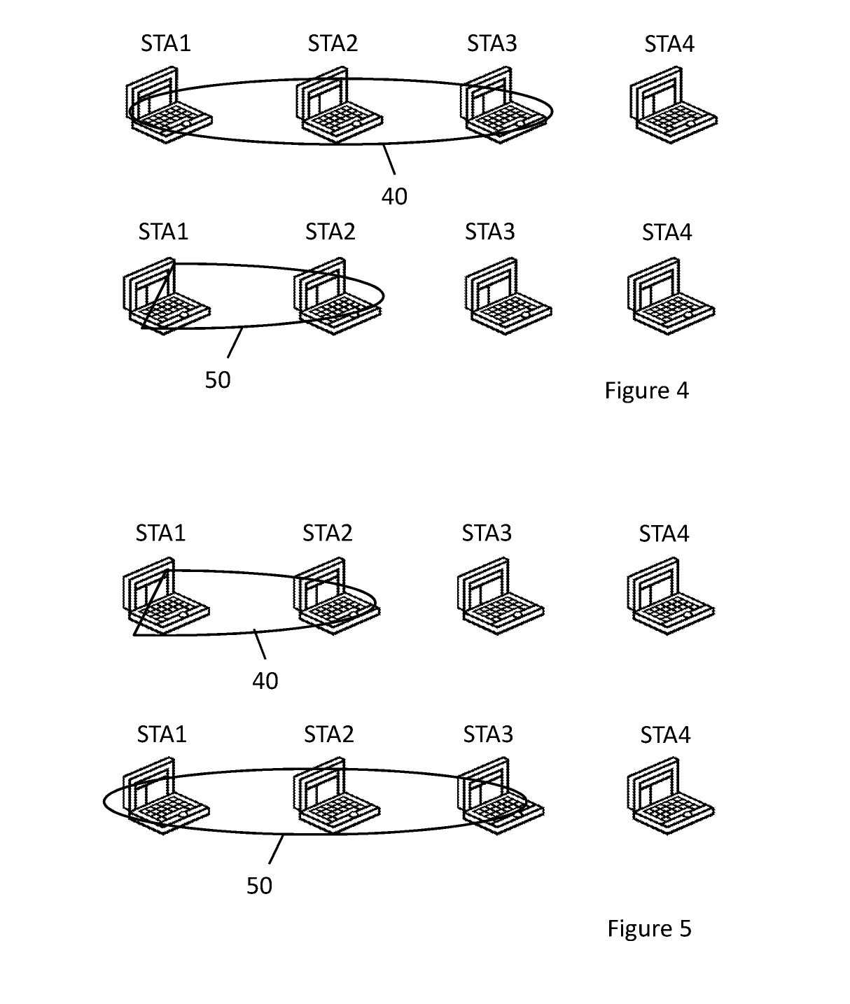

FIG. 4 shows an exposed node scenario. In the scenario shown in FIG. 4, the second station STA2 intends to send a DATA transmission to the first station STA1. The second station STA2 sends a RTS frame 40. The RTS frame 40 is received by the first station STA1 and the third station STA3. In response to the RTS frame 40, the first station STA1 transmits a CTS frame 50. Because the third station STA3 is within range of the second station STA2, but out of range of the first station STA1, the third station STA3 receives the RTS frame 40 but not the CTS frame 50.

FIG. 5 shows a second exposed node scenario. In the scenario shown in FIG. 5, the first station STA1 intends to send a DATA transmission to the second station STA2. The first station STA1 transmits a RTS frame 40. The RTS frame 40 is received by the second station STA2. The third station STA3 is out of range of the first station STA1 and therefore does not receive the RTS frame 40. In response to the RTS frame 40, the second station STA2 transmits a CTS frame 50. The CTS frame 50 is received by the first station STA1 and the third station STA3.

In the exposed node scenarios shown in FIGS. 4 and 5, the third station STA3 can identify that it is an exposed node from the reception of one out of the two RTS/CTS control frames. Further, by extracting the duration value and the type of control frame from the received control frame, the third station STA3 can determine a portion of the duration in which transmissions by the third station STA3 will not interfere with the communication exchange between the first station STA1 and the second station STA2.

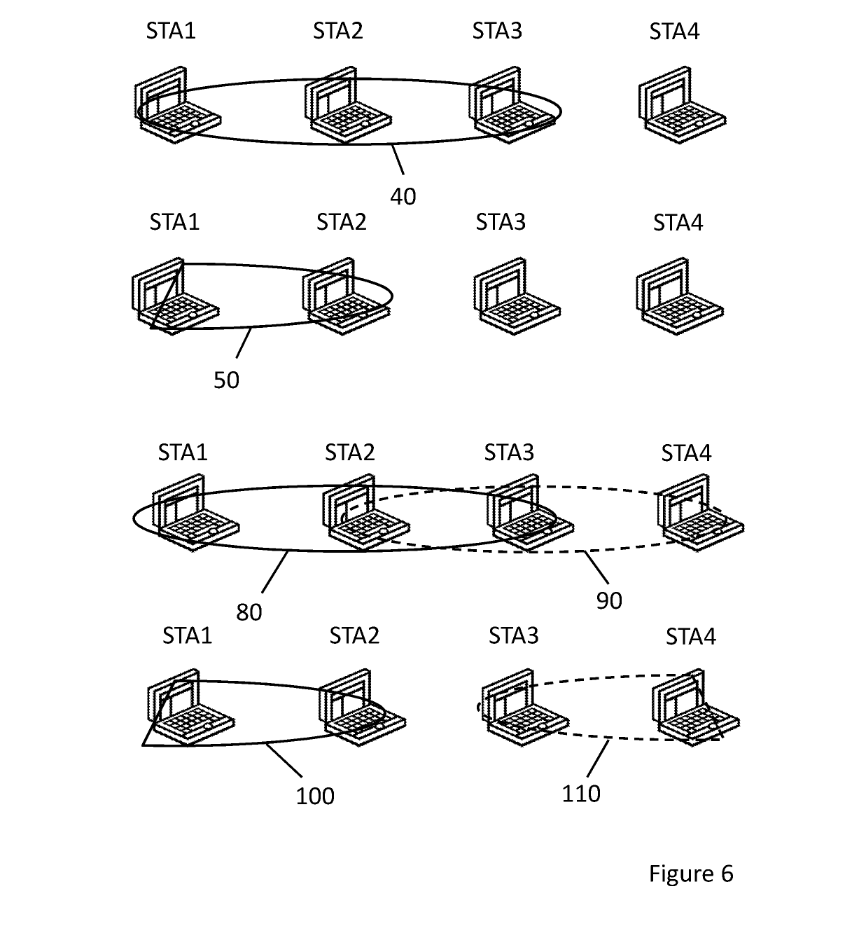

FIG. 6 shows a communication exchange according to an embodiment. The second station STA2 transmits a RTS frame 40 indicating that the second station STA2 intends to send a data packet transmission to the first station STA1. The RTS frame 40 is received by the first station STA1 and the third station STA3. In response to the RTS frame 40, the first station STA1 transmits a CTS frame 50. The CTS frame 50 is received by the second station STA2, but not by the third station STA3 as it is out of range. The third station STA3 identifies that it is an exposed node because it has received only the RTS frame 40 from the RTS/CTS exchange between the first station STA1 and the second station STA2. Further, from the duration information included in the RTS frame 40, the third station STA3 determines the time period when the second station STA2 will be sending a transmission 80 to the first station STA1. During this time period, the third station STA3 sends a transmission 90 to the fourth station STA4. Because the first station STA1 is out of range of the third station STA3, the transmission 90 by the third station STA3 does not interfere with the reception of the transmission 80 by the second station STA2 to the first station STA1. Similarly, because the fourth station STA4 is out of range of the second station STA2, the transmission 80 by the second station STA2 does not interfere with the reception of the transmission 90 by the third station STA3 to the fourth station STA4. The fourth station STA4 sends an acknowledgement (ACK) 110 to the third station STA3 while the first station STA1 is sending an ACK 100 to the second station STA2.

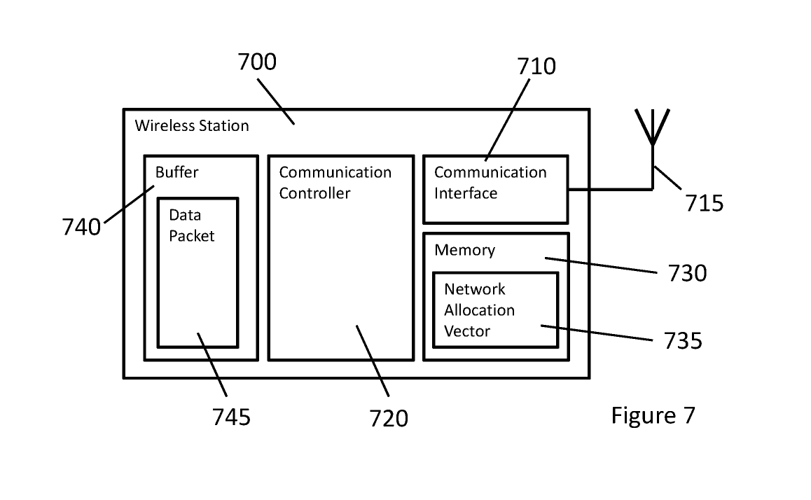

FIG. 7 shows a wireless station (STA) according to an embodiment. The STA 700 comprises a communication interface 710 which is coupled to an antenna 715; a communication controller 720; a memory 730 and a buffer 740. The communication interface 710 is operable to send and receive signals using the antenna 715 on a radiofrequency channel defined in a radiofrequency spectrum. The communication controller 720 is operable to control the communication interface 710 to send and receive data. The memory 730 stores a network allocation vector (NAV) 735. The NAV 735 indicates periods when transmissions onto the radiofrequency channel cannot be initiated by the STA 700. The buffer 740 stores a data packet 745 to be sent by the STA 700 to another wireless station. In the following description, the STA 700 is referred to as the source wireless station and the destination of the data packet 745 is referred to as the destination wireless station.

The communication controller 720 identifies periods in which the STA 700 can transmit the data packet 745 while the radiofrequency channel is in use for communication between other STAs in the network. These periods are referred to in the passage below as communication periods and other STAs using the channel for communication are referred to as first and second stations.

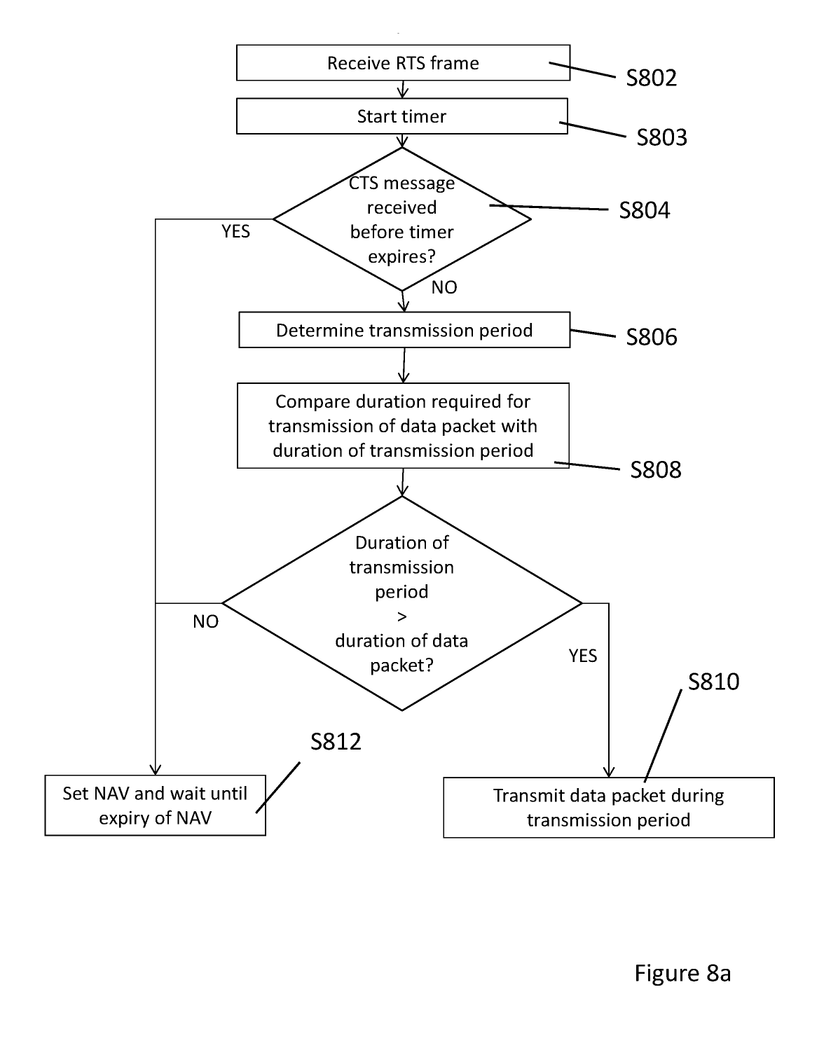

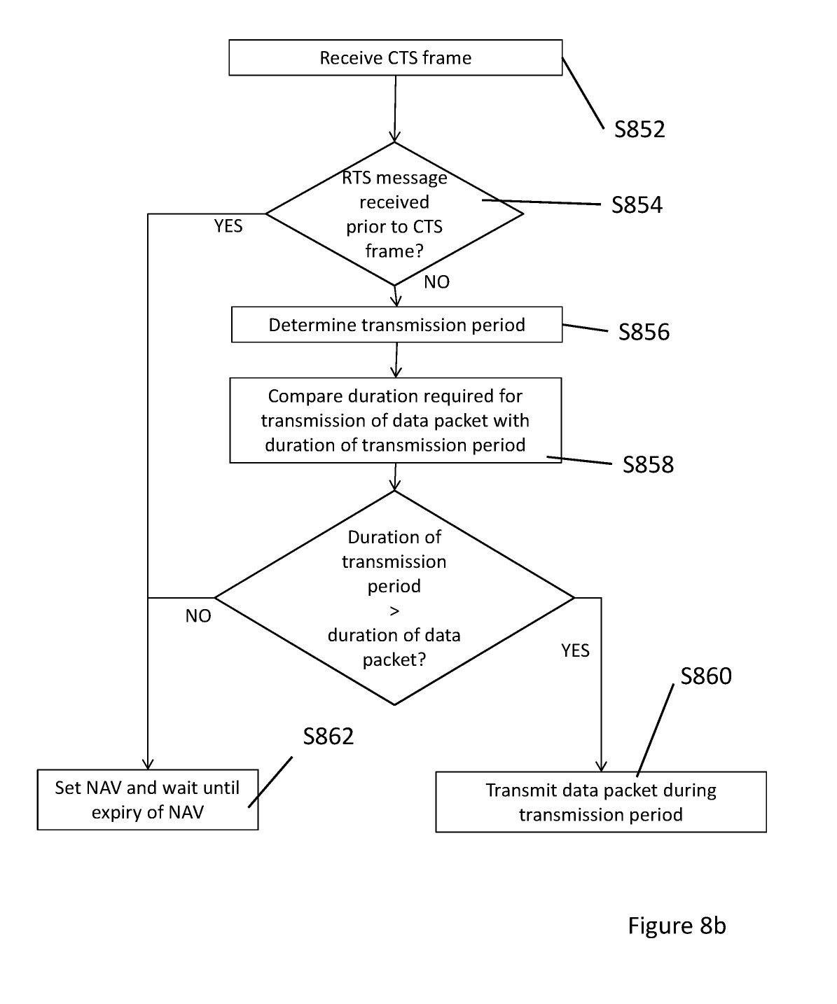

FIG. 8a shows a method of transmitting a data packet according to an embodiment. The method shown in FIG. 8a is carried out by the STA 700 shown in FIG. 7. In step S802, the STA 700 receives a RTS frame transmitted by an STA within range.

In step S803, the STA 700 starts a timer for an expected reception period. When an RTS frame is received, then a CTS frame is expected to be received from the destination of the RTS frame. The expected timing is one short inter frame spacing (SIFS) and the duration of the CTS frame after the RTS frame.

The STA may also store an indication of the address of the first STA which transmitted the RTS message. As discussed below the expected reception period is one SIFS+ the duration of the CTS frame.

The STA 700 may add a small additional buffer period of 1 to 5 μs to allow for timing misalignments between the STAs. If no CTS frame is received by the expiry of the expected reception period, then the STA moves to step S806.

In an embodiment, the STA 700 adapts the duration of the buffer period. This allows the STA 700 to compensate for possible timing misalignments. The buffer period is set to an initial value, for example, 2 μs, and STA 700 follows the method as shown in FIG. 7. If a collision is detected during transmission of the packet, then the STA 700 ceases transmission and increments the duration of the buffer period by a small amount, for example, 1 μs. This incremental increase in the buffer period in the event of a collision reduces the occurrence of such collisions in future cycles of the method as the duration of the buffer period is increased.

If in step S804, the STA 700 determines that the CTS frame has not been received, this indicates that the STA 700 is an exposed node and the method moves to step S806. If the CTS frame is received, then in step S812, the STA 700 sets the NAV 735 to indicate that the channel cannot be accessed for a period determined from the duration indications contained in the RTS and CTS messages.

In step S806, the STA 700 determines a transmission period. The transmission period is determined from the duration indicator in the received RTS frame.

In step S808, the duration of the transmission period is compared with the duration required to transmit the data packet. If the duration of the transmission period is not greater than or equal to the duration required to transmit the data packet, then the method moves to step S812 and the STA 700 sets the NAV and waits until expiry of the NAV. If the duration of the transmission period is greater than or equal to the duration required to transmit the data packet, then in step S810 the STA 700 transmits the data packet in the transmission period.

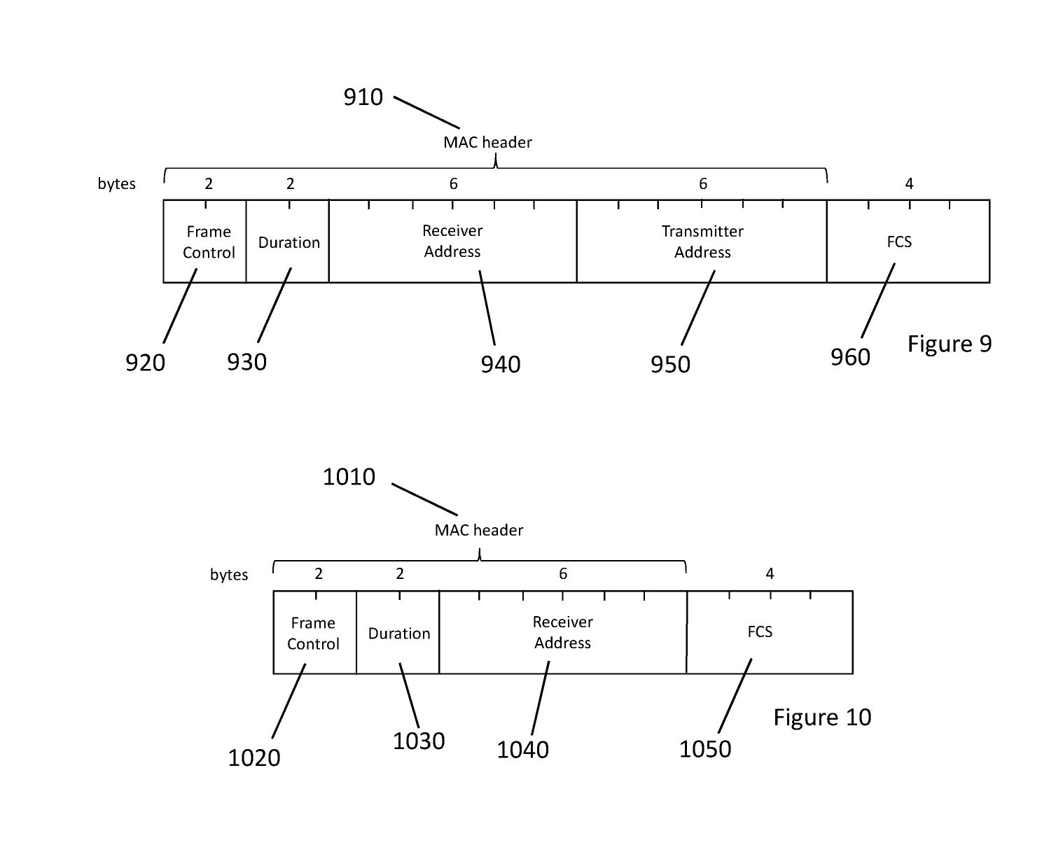

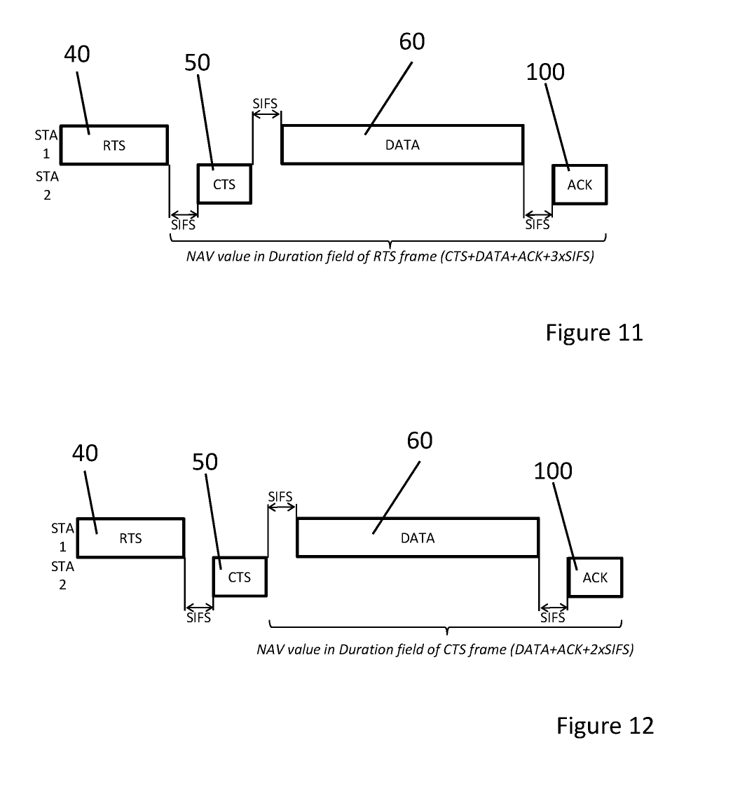

The structure of the control messages is described below with reference to FIGS. 9 and 10 and the calculation of the duration values contained in the control messages is described below with reference to FIGS. 11 and 12.

In an embodiment, the buffer 740 stores a queue of data packets. The data packets in the queue may have different lengths. Once the transmission period has been determined in step S806, the communication controller may then in step S808 successively compare the length of the data packets in the queue with the length of the transmission period until a data packet having a length with is less than the length of the transmission period is identified. The comparison may take place in the order of the data packets in the queue.

In the embodiment described above, the STA 700 determines that no CTS frame has been received and then determines the transmission period, and identifies data packets which may be transmitted during the transmission period. In an embodiment, the STA 700 determines the transmission period prior to the expiry of the timer. The STA 700 may also identify a data packet from the queue prior to expiry of the timer.

In an embodiment, when the STA 700 receives a RTS frame, it stores the address of the destination of the RTS. This allows the STA 700 to check that the destination is not the same as the intended destination of the packet stored in the buffer 740. If the intended destination of the packet stored in the buffer is the same as the destination of the RTS, then the STA 700 must wait until the communication exchange is completed before transmitting the packet stored in the buffer as the STA to which it intends to transmit will be busy since it will be receiving the data transmitted by the source of the RTS frame.

FIG. 8b shows a method of transmitting a data packet according to an embodiment. The method shown in FIG. 8b is carried out by the STA 700 shown in FIG. 7. In step S852, the STA 700 receives a CTS frame transmitted by an STA within range.

In step S852, the STA determines whether an RTS frame was received prior to the CTS frame. If the first message received is a CTS frame, then the STA 700 determines that no corresponding RTS frame has been received by checking whether the timer is running. If the timer has not been set or has expired, then the STA 700 determines that no corresponding RTS frame has been received moves to step S856.

As discussed above, the STA 700 may store an indication of the address of the sender of RTS messages. If the STA 700 stores an indication of the address of the sender of RTS frames when received, then when a CTS frame is received, the STA may also check the destination address of the CTS frame to verify that the CTS frame was transmitted in response to the received RTS frame.

If in step S854, the STA 700 determines that no corresponding RTS frame was received prior to the CTS frame, this indicates that the STA 700 is an exposed node in the scenario shown in FIG. 5, and the method moves to step S856. If a corresponding RTS frame was received, then in step S862, the STA 700 sets the NAV 735 to indicate that the channel cannot be accessed for a period determined from the duration indications contained in the RTS and CTS messages.

In step S856, the STA 700 determines a transmission period. The transmission period is determined according to the duration indicator in the received CTS frame.

In step S858, the duration of the transmission period is compared with the duration required to transmit the data packet. If the duration of the transmission period is not greater than or equal to the duration required to transmit the data packet, then the method moves to step S862 and the STA 700 sets the NAV and waits until expiry of the NAV. If the duration of the transmission period is greater than or equal to the duration required to transmit the data packet, then in step S860 the STA 700 transmits the data packet in the transmission period.

FIG. 9 shows the structure of a request to send (RTS) frame. The RTS frame 900 comprises a medium access control (MAC) header 910 and a frame check sequence (FCS) 960. The MAC header 910 comprises a frame control field 920, a duration field 930, a Receiver Address 940 and a Transmitter Address 950. The FCS 960 contains a number that is calculated by the source of the RTS frame 900 and is used by the destination of the RTS frame 900 to detect errors. A cyclic redundancy check algorithm may be used to calculate the FCS 960. The frame control field 920 is 2 bytes in length, the duration field 930 is 2 bytes in length, the receiver address 940 is 6 bytes in length, the transmitter address 950 is 6 bytes in length and the FCS 960 is 4 bytes in length.

The frame control field 920 includes an indication of the frame type and sub type. In this case, the frame type is a control frame and the sub type is an RTS frame.

The Duration field 930 includes an indication of the duration of the transmission exchange between the transmitter (STA1) and the receiver (STA2). As discussed in more detail with reference to FIG. 11 below, the value of the duration is calculated from the total of the length of a CTS frame, the length of the DATA frame to be transmitted by the transmitter, the length of an ACK frame and three SIFS lengths.

The Receiver Address 940 indicates the MAC Address of the station that is intended to receive the DATA frame which the transmitter will send.

The Transmitter Address 950 indicates the MAC Address of the station transmitting the RTS frame.

FIG. 10 shows the structure of a clear to send (CTS) frame. The CTS frame comprises a MAC header 1010 and a frame check sequence (FCS) 1050. The MAC header 1010 comprises a Frame Control field 1020, a Duration field 1030, and a Receiver Address 1040. The FCS 1050 includes a number calculated by the sender of the CTS frame which is used by the receiver of the CTS frame to detect errors.

The frame control field 1020 is 2 bytes in length, the duration field 1030 is 2 bytes in length, the receiver address 1040 is 6 bytes in length and the FCS 1050 is 4 bytes in length.

The Frame Control portion 1020 includes an indication of the frame type which is a control frame and an indication of the frame sub type which is a CTS frame.

The Duration field 1030 includes an indication of the duration of the remainder of the transmission exchange following the CTS frame. As discussed in more detail with reference to FIG. 12 below, the value of the duration is calculated from the total of the length of the DATA frame to be transmitted by the transmitter, the length of an ACK frame and two SIFS lengths.

FIG. 11 shows the calculation of the NAV value in the duration field of an RTS frame. As shown in FIG. 11, a first station STA1 transmits an RTS frame 40 to a second station STA2. After receiving the RTS frame 40, the second station STA2 waits for a short inter frame spacing (SIFS) and then transmits a CTS frame 50 to the first station STA1. After receiving the CTS frame 50, the first station STA1 waits for a SIFS and then transmits a DATA frame 60 including a data packet to the second station STA2. After receiving the DATA frame 60, the second station STA2 waits for a SIFS and then transmits an ACK frame 100 to the first station STA1.

As shown in FIG. 11, the NAV value in the duration field of the RTS frame 40 is calculated from the length of the transmission exchange that follows the RTS frame 40. This is CTS+DATA+ACK+3×SIFS, where CTS is the length of the CTS frame 50, DATA is the length of the DATA frame 60, ACK is the length of the ACK frame 100 and SIFS is the length of the SIFS.

FIG. 12 shows the calculation of the NAV value in the duration field of a CTS frame. The transmission exchange is as described above in relation to FIG. 11. As shown in FIG. 12, the NAV value in the duration field of the CTS frame 50 is calculated from the length of the transmission exchange that follows the CTS frame 50. This is DATA+ACK+2×SIFS, where DATA is the length of the DATA frame 60, ACK is the length of the ACK frame 100 and SIFS is the length of the SIFS.

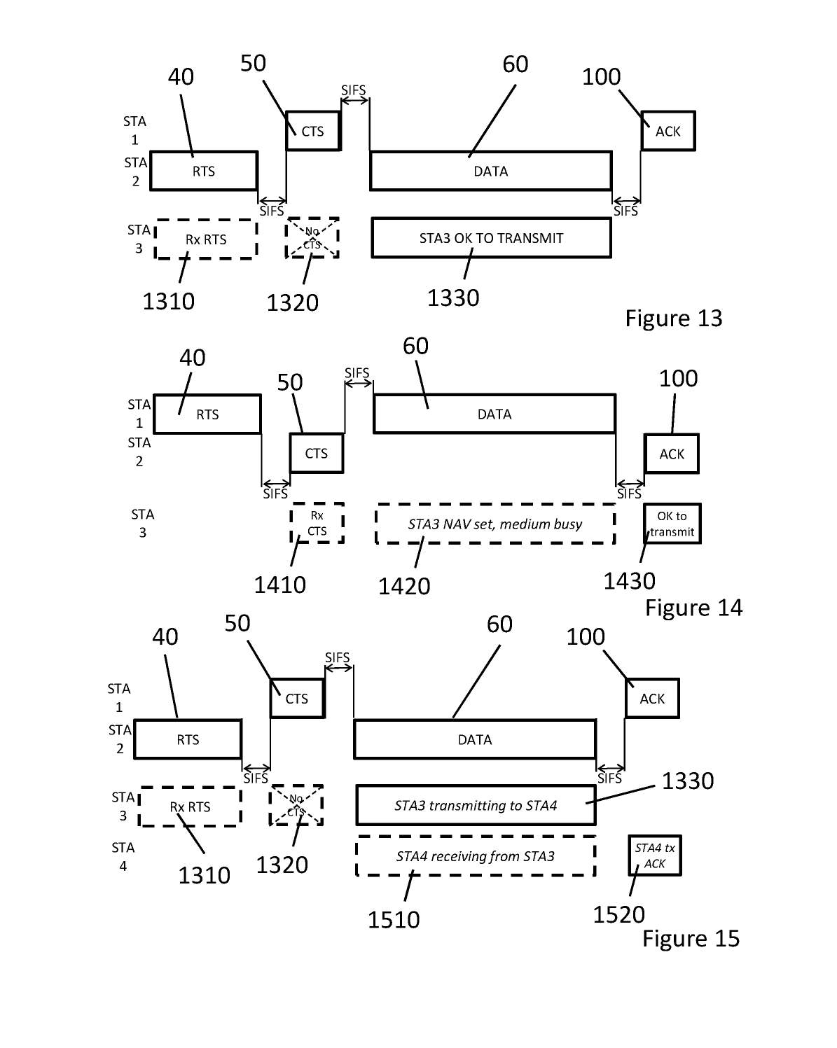

FIG. 13 shows a wireless communication method according to an embodiment. As shown in FIG. 13, information from a RTS/CTS exchange between a first wireless station STA1 and a second wireless station STA2 is used by a third wireless station STA3 to determine when the third station STA3 can transmit a data packet to a destination wireless station.

In the scenario shown in FIG. 13, the third wireless station STA3 is within range of the second wireless station STA2, but not within range of the first wireless station STA1. The scenario is as shown FIG. 4.

The second wireless station STA2 transmits a RTS frame 40 to the first wireless station STA1. The RTS frame 40 is received by the third wireless station STA3 during this time period 1310. From the information included in the frame control field of the RTS frame 40, the third station STA3 identifies the received control frame as a RTS frame. Further, the third station STA3 extracts the information included in the duration field of the RTS frame 40. From this information, the third station STA3 can determine when the first station STA1 and the second station STA2 will each be transmitting.

In response to the RTS frame 40, the first station STA1 waits a SIFS and then transmits a CTS frame 50. The third station STA3 does not receive the CTS frame 50. The third station STA3 can determine the expected time period 1320 when the CTS frame 50 is transmitted since the SIFS fixed by the communication protocol being used by the first station STA1 and the second station STA2.

The second station STA2 waits for a SIFS after receiving the CTS frame 50 and then transmits a data frame 60. Following the reception of the data frame 60 by the first station STA1, the first station STA1 waits for a SIFS and then transmits an ACK frame 100 to the second station STA2.

The third station STA3 can determine the time period 1330 that the second station STA2 will be transmitting the data frame 60. The time period 1330 is determined by the third station STA3 from the duration field of the RTS frame 40. Here it is noted that the lengths of the CTS, ACK and the SIFS are fixed, and therefore the length of the DATA frame 60 can be determined from the duration field of the RTS frame 40.

The third station STA3 determines that it can transmit on the channel during the time period 1330 when the second station STA2 is transmitting. Since the first station STA1 is out of range of the third station STA3, the transmission by the third station STA3 during this time period 1330 will not reach the first station STA1 and will therefore not interfere with the transmission 60 by the second station STA2 to the first station STA1.

FIG. 14 shows a wireless communication method according to an embodiment. In the scenario shown in FIG. 14, the third station STA3 is out of range of a first station STA1 which transmits the RTS frame 40 and within range of the second station STA2 which transmits the CTS frame 50. The scenario shown in FIG. 14 corresponds to FIG. 5 described above.

As shown in FIG. 14, the first station STA1 transmits a RTS frame 40 to the second station STA2. The third station STA3 is out of range of the first station STA1 and therefore does not receive the RTS frame 40. After receiving the RTS frame 40, the second station STA2 waits for a SIFS and transmits a CTS frame 50. The CTS frame 50 is received by the third station STA3.

After receiving the CTS frame 50, the first station STA1 waits for a SIFS and then transmits a data frame 60. After receiving the data frame 60, the second station STA2 waits for a SIFS and then transmits an ACK frame 100 to the first station STA1.

As described above, the third station STA3 receives the CTS frame 50, from the reception 1410 of the CTS frame 50, the third station STA3 can determine that a RTS frame would have been transmitted by the first station STA1 and the expected timing of the RTS frame. Since the RTS frame 40 was not received by the third station STA3 during the expected timing ending one SIFS before the CTS frame 50 was received, the third station STA3 determines that the first station STA1 is out of range.

In response to receiving the CTS frame 50, the third station STA3 sets the NAV in its memory to indicate that the communication medium will be busy for the period 1420 while the first station STA1 is transmitting the data frame 60. The period for which the NAV set is determined from the duration value in the CTS frame 50, and the values for the SIFS timing and ACK frame timing which are fixed.

The third station STA3 determines that it can transmit in the time period 1430 that the second station STA2 is transmitting the ACK 100.

FIG. 15 shows a wireless communication method according to an embodiment. The scenario shown in FIG. 15 corresponds to the arrangement illustrated in FIG. 6. Here, the third station STA3 transmits to a fourth station STA4 which is out of range of the first station STA1 and the second station STA2.

The second station STA2 transmits a RTS frame 40 to the first station STA1. The third station STA3 receives the RTS frame during this time period 1310. From the information included in the frame control field of the RTS frame 40, the third station STA3 identifies the received control frame as a RTS frame. Further, the third station STA3 extracts the information included in the duration field of the RTS frame 40. From this information, the third station STA3 can determine when the first station STA1 and the second station STA2 will each be transmitting.

In response to the RTS frame 40, the first station STA1 waits a SIFS and then transmits a CTS frame 50. The third station STA3 does not receive the CTS frame 50. The third station STA3 can determine the expected time period 1320 when the CTS frame 50 is transmitted since the SIFS fixed by the communication protocol being used by the first station STA1 and the second station STA2. As discussed above, the third station STA3 may wait an additional buffer period before determining that the CTS frame 50 has not been received.

The second station STA2 waits for a SIFS after receiving the CTS frame 50 and then transmits a data frame 60. Following the reception of the data frame 60 by the first station STA1, the first station STA1 waits for a SIFS and then transmits an ACK frame 100 to the second station STA2.

The third station STA3 determines a transmission period 1330 in which it can transmit to the fourth station STA4 without interfering with the communication exchange between the first station STA1 and the second station STA2. The transmission period 1330 is determined by the third station STA3 from the duration field of the RTS frame 40. As mentioned above, the lengths of the CTS, ACK and the SIFS are fixed, and therefore the length of the DATA frame 60 can be determined from the duration field of the RTS frame 40.

The third station STA3 determines that it can transmit on the channel during the time period 1330 when the second station STA2 is transmitting. Since the first station STA1 is out of range of the third station STA3, the transmission by the third station STA3 during this time period 1330 will not reach the first station STA1 and will therefore not interfere with the transmission 60 by the second station STA2 to the first station STA1.

The fourth station STA4 receives the transmission from the third station STA3 during a period 1510. Once the transmission from the third station STA3 to the fourth station STA4 finishes, the fourth station STA4 transmits an acknowledgement 1520 to the third station STA3. As shown in FIG. 15, the third station STA3 can receive the acknowledgement 1520 transmitted by the fourth station STA4 as the acknowledgement 1520 is transmitted while the first station STA1 which is out of range of the third station STA3 is transmitting an ACK 100.

In the embodiments described above, the duration field included in received control frames is used to determine the period in which the third station may transmit. This allows embodiments to account for the fact that the lengths of packets may vary depending on the amount of data transmitted or the frame type.

In an embodiment, a wireless station, such as the third station STA3 in the examples described above has a simultaneous transmit and receive (STR) function and can therefore monitor the transmission by the second station STA2 while transmitting. In this embodiment the third station STA3 uses the STR function to determine the period that the second station STA2 is transmitting and sends the data packet during this period.

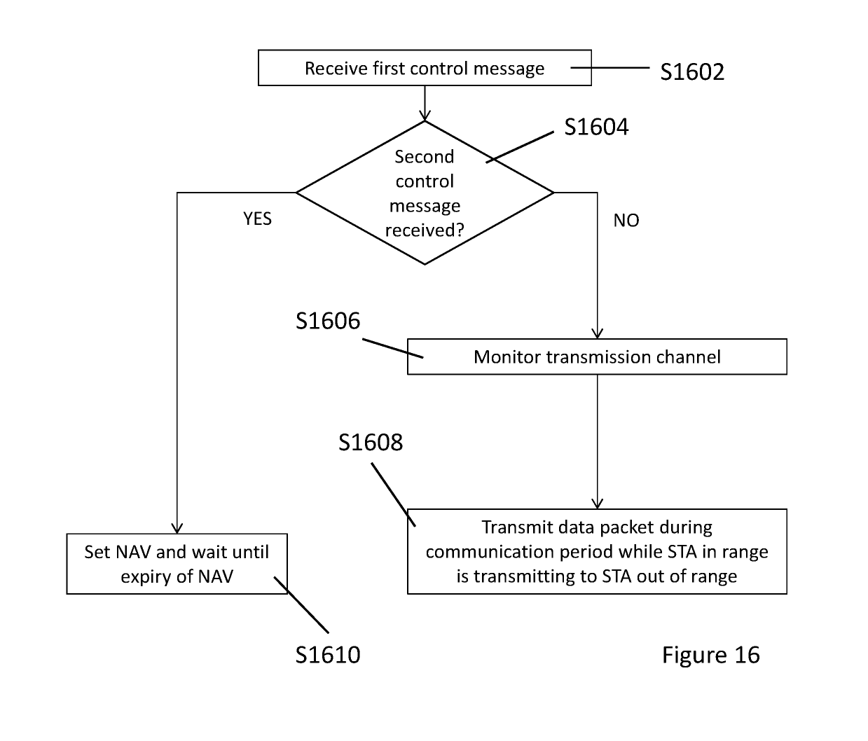

FIG. 16 shows a method of transmitting a data packet according to an embodiment. The method shown in FIG. 16 is carried out by an STA with an STR function. In step S1602, the STA receives a first control message. The first control message may be either a RTS frame transmitted by an STA within range, or a CTS frame transmitted by an STA within range.

In step S1604, the STA determines whether a second control message has been received. If the first control message received is a RTS control message, then the second control message will be a CTS message and the expected timing of the second control message is one short inter frame spacing (SIFS) and the duration of a CTS message after the RTS message.

If the first control message is a RTS message, then the STA sets a timer with the expected reception period in which a CTS message is expected. The STA may also store an indication of the address of the first STA which transmitted the RTS message. As discussed above the expected reception period is one SIFS+ the duration of the CTS frame. The STA may add a small additional buffer period of 1 to 5 μs to allow for timing misalignments between the STAs. If no CTS frame is received by the expiry of the expected reception period, then the STA moves to step S1606.

If the first message received is a CTS message, then the STA determines that no corresponding RTS message has been received by checking whether the timer is running. If the timer has not been set or has expired, then the STA determines that no corresponding RTS message has been received moves to step S1606.

If a second control message has been received, the method moves to step S1610 and the STA sets the NAV and waits until expiry of the NAV.

If in step S1604, the STA determines that the second control message has not been received, this indicates that the STA 700 is an exposed node and the method moves to step S1606. Both control messages are received, then the STA sets the NAV to indicate that the channel cannot be accessed for a period determined from the duration indications contained in the RTS and CTS messages.

In step S1606, the STA monitors the channel to determine when the STA which transmitted the received control message is transmitting. This allows the STA to identify the periods such as 1330 shown in FIG. 13 in which it can transmit without the transmission colliding with the communication exchange between the first station STA1 and the second station STA2.

In step S1608, the STA transmits a data packet to be transmitted while the second station STA2 is also transmitting. When the second station STA2 stops transmitting, the STA also stops transmitting as the first station STA1 which is out of range may then start transmitting an ACK to the second station STA2 and the transmission by the STA could collide with this ACK.

In an embodiment the use of an STR function as described above is combined with the extraction of NAV information from the duration field of a received RTS or CTS control frame. By monitoring the channel, the STA can identify and avoid other STAs that are also opportunistically using the channel.

The specific embodiments are presented schematically. The reader will appreciate that the detailed implementation of each embodiment can be achieved in a number of ways. For instance, a dedicated hardware implementation could be designed and built. On the other hand, a processor could be configured with a computer program, such as delivered either by way of a storage medium (e.g. a magnetic, optical or solid state memory based device) or by way of a computer receivable signal (e.g. a download of a full program or a “patch” update to an existing program) to implement the management unit described above in relation to the embodiments. Besides these two positions, a multi-function hardware device, such as a DSP, a FPGA or the like, could be configured by configuration instructions.

Whilst certain embodiments have been described, these embodiments have been presented by way of example only, and are not intended to limit the scope of the inventions. Indeed, the novel wireless stations, and methods described herein may be embodied in a variety of other forms; furthermore, various omissions, substitutions and changes in the form of the devices, methods and products described herein may be made without departing from the spirit of the inventions. The accompanying claims and their equivalents are intended to cover such forms or modifications as would fall within the scope and spirit of the inventions.

1. A method, in a source wireless station, of transmitting a data packet to a destination wireless station over a communication channel of a wireless network while the communication channel is in use for a communication exchange between a first wireless station and a second wireless station, the method comprising:
receiving a request to send message transmitted by the first wireless station on the communication channel, the request to send message comprising an indication of a duration that the communication channel will be in use during the communication exchange between the first wireless station and the second wireless station;
determining if a clear to send message transmitted from the second wireless station to the first wireless station is received in an expected reception period following the request to send message;
determining a transmission period, the transmission period being a part of the duration in which transmission on the communication channel by the source wireless station will not interfere with the communication exchange between the first wireless station and the second wireless station;
comparing the duration of the transmission period with a duration required for transmission of the data packet; and
transmitting the data packet during the transmission period if a clear to send message is not received in the expected reception period and the duration of the transmission period is longer than or equal to the duration required for transmission of the data packet.

2. A method according to claim 1, wherein determining if a clear to send message transmitted from the second wireless station to the first wireless station is received in an expected reception period following the request to send message comprises setting a timer for the duration of the expected reception period at the end of reception of the request to send message.

3. A method according to claim 1 wherein the expected reception period has a duration of at least one short inter frame spacing and the duration of a clear to send message.

4. A method according to claim 3 wherein the expected reception period has a duration of one short inter frame spacing, the duration of a clear to send message and a buffer period.

5. A method according to claim 4, further comprising detecting a collision between the data packet transmitted during the transmission period and the communication between the first wireless station and the second wireless station, and increasing the duration of the buffer period.

6. A method according to claim 1, comprising determining the transmission period as the period when the first wireless station will be transmitting to the second wireless station.

7. A method according to claim 1, further comprising comparing the length of the transmission period with the length of a plurality of candidate data packets and selecting a candidate data packet having a length less than the transmission period as the data packet.

8. A method according to claim 1, further comprising monitoring the communication channel during the transmission period and stopping the transmission of the packet if a transmission from a further wireless station is identified.

9. A method according to claim 1, further comprising determining the identity of the first wireless station from a transmitter address of the request to send message, and comparing the transmitter address of the request to send message with a destination address of a received clear to send message to determine that the clear to send message was transmitted in response to the request to send message.

10. A method, in a source wireless station, of transmitting a data packet to a destination wireless station over a communication channel of a wireless network while the communication channel is in use for a communication exchange between a first wireless station and a second wireless station, the method comprising:
receiving a clear to send message transmitted by the first wireless station on the communication channel, the clear to send message comprising an indication of a duration that the communication channel will be in use for the communication exchange between the first wireless station and the second wireless station;
determining if a request to send message transmitted from the second wireless station to the first wireless station was received prior to reception of the clear to send message
if a request to send message was not received prior to reception of the clear to send message, determining a transmission period, the transmission period being a part of the duration in which transmission on the communication channel by the source wireless station will not interfere with the communication exchange between the first wireless station and the second wireless station;
comparing the duration of the transmission period with a duration required for transmission of the data packet; and
transmitting the data packet during the transmission period if the duration of the transmission period is longer than or equal to the duration required for transmission of the data packet.

11. A method according to claim 10, further comprising setting a timer for a duration of an expected reception period if a request to send message is received and determining that a request to send message was not received prior to reception of the clear to send message if the timer is not running or has expired when the clear to send message is received.

12. A method, in a source wireless station, of transmitting a data packet to a destination wireless station over a communication channel of a wireless network while the communication channel is in use for a communication exchange between a first wireless station and a second wireless station, the method comprising:
receiving a request to send message transmitted by the first wireless station on the communication channel;
determining if a clear to send message transmitted from the second wireless station to the first wireless station is received in an expected reception period following the request to send message;
if a clear to send message is not received in the expected reception period, monitoring the communication channel; and
transmitting the data packet while a signal from the first wireless station is received.

13. A wireless station comprising
a communication interface configured to receive a request to send messages and clear to send messages on a communication channel and to transmit messages on the communication channel;
storage for a data packet to be transmitted on the communication channel; and
a communication controller configured to:
set a timer to an expected reception period when a request to send message is received by the communication interface, determine a transmission period from duration information included in the received request to send message, compare the duration of the transmission period with the duration required to transmit the data packet; and control the communication interface to transmit the data packet during the transmission period if no clear to send message in response to the request to send message is received before the timer expires and the duration of the transmission period is longer than or equal to the duration required to transmit the data packet.

14. A wireless station according to claim 13 wherein the storage is configured to store a queue of data packets and the communication controller is configured to compare the duration of the transmission period with the durations required for transmission of the data packets in the queue and identify a data packet having a duration required for transmission which is less than or equal to the duration of the transmission period.

15. A wireless station according to claim 13, wherein the communication controller is further configured to determine on reception of a clear to send message if the timer has expired, and if the timer has expired, determine a transmission period from duration information included in the received clear to send message, compare the length of the transmission period with the length of the data packet; and control the communication interface to transmit the data packet during the transmission period if the length of the transmission period is longer than the length of the data packet.

16. A wireless station according to claim 13, wherein the communication controller is further configured to monitor the communication channel during the transmission period and to stop the transmission of the packet if a transmission from a further wireless station is identified.

17. A wireless station according to claim 13, wherein the communication controller is further configured to store an indication of a transmitter address of a request to send message received by the communication interface, and compare the transmitter address of the request to send message with a destination address of a received clear to send message and determine that the clear to send message is in response to the request to send message if the transmitter address matches the destination address.

18. A wireless station comprising
a communication interface configured to receive a request to send messages and clear to send messages on a communication channel and to transmit messages on the communication channel;
storage for a data packet to be transmitted on the communication channel; and
a communication controller configured to:
set a timer to an expected reception period when a request to send message is received by the communication interface, if no clear to send message in response to the request to send message is received before the timer expires; monitor the communication channel to determine when a first wireless station that transmitted the request to send message is transmitting and control the communication interface to transmit the data packet while the first wireless station is transmitting.

19. A computer readable carrier medium carrying processor executable instructions which when executed on a processor cause the processor to execute a method according to claim 1.

20. A computer readable carrier medium carrying processor executable instructions which when executed on a processor cause the processor to execute a method according to claim 8.
